(19) United States
(12) Patent Application Publication
(10) Pub. No.: US 2010/0122347 A1
(43) Pub. Date: May 13, 2010

(54) AUTHENTICITY RATINGS BASED AT LEAST IN PART UPON INPUT FROM A COMMUNITY OF RATERS

(75) Inventor: SIMA NADLER, KOCHAV YAIR (IL)

Correspondence Address: PATENTS ON DEMAND, P.A.-IBM ACCSPP, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/270,587

(22) Filed: Nov. 13, 2008

(51) Int. Cl. G06F 7/04

(52) U.S. Cl. 726/26

(57) ABSTRACT

A rating option can be provided within a user interface. The rating option can permit an interface user to provide a quantitative indication regarding an option of whether a profile detailing identification data for an on-line entity is accurate. Rating input can be received using the rating option from a set of raters. An identity score that indicates a confidence level that the profile data of an on-line entity is accurate can be calculated based at least in part upon the rating input from the set of raters. In various embodiments, the identity score can also be based at least in part upon self-verification information provided by the on-line entity and information provided by one or more identity authorities. An authenticity rating based upon the calculated identity score can be presented to communicators able to interact on-line with the on-line entity.

### BACKGROUND

The present invention relates to the field of identity authentication, more particularly to calculating an authenticity rating for a user based on provided authenticity data.

In modern communication, it is common to interact with other users over the internet via instant messaging, social networks, IP (internet protocol) telephony, and many other similar communication services. In many of these instances, we prefer to interact only with people whom we know or feel are presenting themselves honestly. Currently, users can easily create accounts to use these services using false information. Also, in some instances it can be easy for a user to exploit a security flaw to gain access to another user's account. People who falsely represent themselves can be using these services for malicious purposes. Currently, it is the user's responsibility to determine if a user is representing their identity honestly. At present, no real identify verification policies or techniques exist that permit users to gauge an accuracy of another user's representation of himself or herself.

### BRIEF DESCRIPTION OF THE SEVERAL VIEWS OF THE DRAWINGS

FIG. 1 is a schematic diagram of a system for calculating an authenticity rating for a user based on provided authenticity data in accordance with an embodiment of the inventive arrangements disclosed herein.

FIG. 2 illustrates a set of user interfaces associated with an authenticity rating in accordance with an embodiment of the inventive arrangements disclosed herein.

FIG. 3 is a flow chart of a method for calculating authenticity ratings in accordance with an embodiment of the inventive arrangements disclosed herein.

### DETAILED DESCRIPTION

The disclosure teaches calculating an authenticity rating for an on-line entity (e.g., user) based on provided authenticity data. This authentication rating can be presented to other users before and during interactions to permit users to gauge the likelihood that another user has properly represented himself or herself. The authentication data upon which an authenticity rating is based can come from a set of users who have interacted with a rated user, from a rated user himself/herself, and/or from one or more authority sources. For example, after an interaction, a user can provide a rating reflecting whether they believe the person with whom they just interacted is authentic. These ratings can be gathered and statistically processed to form a community established authenticity rating. A user can self-verify by presenting additional verifiable information, such as zip code, social security number, birthplace, mother's maiden name, a biometric input, and the like. Correct self verification data determined by comparisons against a trusted data source can improve that user's authenticity rating. Further, authority sources, such as utility companies, banks, internet service providers, and the like, which possess some knowledge of a person's residence, communication origination, and/or identity can be used to confirm/refute user provided identification information to affect a user's authenticity rating.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

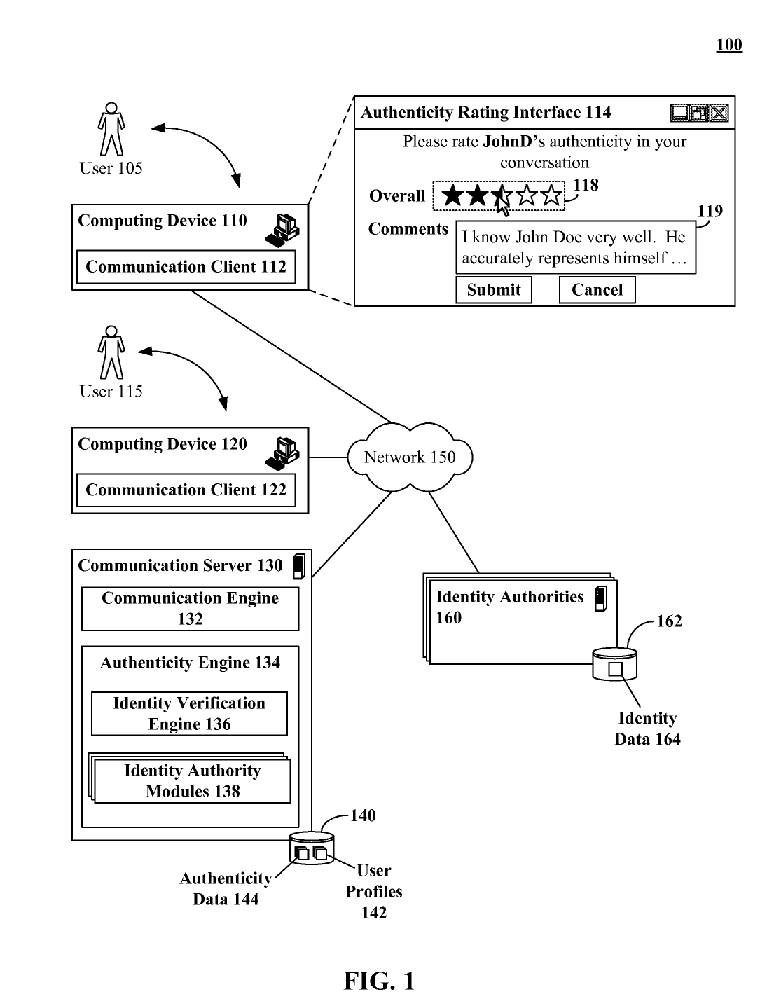

FIG. 1 is a schematic diagram of a system 100 for calculating an authenticity rating for a user based on provided authenticity data in accordance with an embodiment of the inventive arrangements disclosed herein. In system 100, various users 105, 115 can communicate with each other over network 150 using computing devices 110, 122. The communications can be facilitated by a communication server 130. For each user 105, 115 an authenticity engine 134 can calculate an authentication rating 118, which is presented to other users 105, 115. The authentication rating 118 can indicate a likelihood of whether the user associated with the rating 118 has provided accurate identification information, which is recorded in user profile 142. That is, the authentication rating 118 can be an indication of whether a user is really who he/she professes to be.

The calculated rating 118 can be based at least in part upon input provided by other users of a community to which the rated user belongs. For example and as shown in system 100, user 105 can use authenticity rating interface 114 to input an authentication rating 118 for another user 115. The rating 118 can represent an option by user 105 as to whether user profile 142 information for user 115 is accurate. Additional comments 119 and other information can be provided as part of the rating process. The information input by user 105 via interface 114 can be stored as authenticity data 144 in data store 140.

In one embodiment, interface 114 can be integrated with a communication application (associated with communication server 130 and communication engine 132), which permits user-to-user interactions. These user-to-user interactions can occur via interfaces of communication client 112 and communication client 122, which are able to interact with communication server 130. The communication application can, for example, be a social networking application, an IM application, an email application, an electronic gaming application, and the like.

In another embodiment, interface 114 can be associated with a rating application and/or service, which is independent of any specific communication application. When authentication ratings are independent of a communication application, the authentication rating data can be shared among multiple different communication applications. Specifics shown in system 100 (which illustrates an implementation where authenticity engine 134 is integrated with a communication server engine 132) can be modified in embodiments where authentication independence is desirable. For example, a separate authentication server (not shown in system 100) can be communicatively linked to network 150, where the authentication server includes authentication engine 134 and has access to data store 140. Further, the computing devices 110, 120 used by users 105, 115 need not include compatible communication clients 112, 122 as inter-user communication is not required for viewing and/or submitting authentication rating data, especially in embodiments where authentication ratings are independent of communication applications.

In one embodiment, a set of factors other than a community provided rating 118 can affect an authentication rating. One of these factions can be based upon verifiable information provided by a user to improve their own authenticity rating. For example, a user can input their zip code, a driver's license number, a high school, biometric input, and the like. This information can be verified from a trusted source. In one embodiment, the trusted source can be any data source which the user providing the information is unable to edit. A set of identity authorities 160 can exist with manage a repository 162 of identity data 164, which can be compared against data of a user profile 142.

As used herein, computing devices 110 and 120 can be any device that can allow remotely located users 105, 115 to interact and to provide and view authenticity rating information. For example, computing devices 110 and 120 can include, but are not limited to, a desktop computer, a mobile phone, a laptop computer, a gaming console, and the like.

Communication clients 112 and 122 can be software applications facilitating communication between users 105, 115. The communications can be peer-to-peer communications or can be facilitated by communication server 130. Clients 112, 122 can be stand-alone applications or can be Web applications rendered in a browser. Clients 112, 122 can include, but are not limited to, an e-mail client, a text exchange client, an instant messaging client, a voice over internet protocol (VOIP) client, a social networking client, a contact management client, and the like.

Communication server 130 can be a set of one or more computing device, which hosts communication engine 132. Communication server can be implemented as a stand-alone physical server, a cluster of physical servers, a virtual server, and the like.

Communication engine 132 can facilitate communications, real-time or otherwise, between users over network 150. A communication service provided by engine 132 can be optionally incorporated into a different service, such as a social networking service.

Authenticity engine 134 can use authenticity data 144 and user profiles 142 to determine an authenticity rating for a user. User profile 142 can contain the identity data for a user, which may be provided by that user or some other unverified source. Authenticity data 144 can contain measurable forms of data can be unique and identifiable for a user. Authentication engine 134 can include an identity verification engine 136. Identity verification engine 136 can provide data regarding whether or not authenticity data is valid.

Identity authorities 160 can be trusted authorities which can host identity data 164. These institutions can store private secure data for their users as identity data 164. Such institutions can include utility providers (i.e. phone service, electricity, internet service), a bank or credit bureau, a government authority, a security provider (i.e. has biometric data for fingerprint and visual identification), and the like. Each of these institutions can store unique and identifiable data for users. This data can be stored as identity data 164. In one embodiment, a set of identity authority modules 138 may be required to interact with one or more of the identity authorities 160. These modules 138 can provide any security credentials needed to access the identity data 164. The modules 138 can also provide data reconciliation rules for comparing data 142, 164 stored in different formats.

Data stores 140 and 162 can be physically implemented within any type of hardware including, but not limited to, a magnetic disk, an optical disk, a semiconductor memory, a digitally encoded plastic memory, a holographic memory, or any other recording medium. The data stores 140 and 162 can be a stand-alone storage unit as well as a storage unit formed from a set of physical devices, which may be remotely located from one another. Additionally, information can be stored within each data store in a variety of manners. For example, information can be stored within a database structure or can be stored within one or more files of a file storage system, where each file may or may not be indexed for information searching purposes.

Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

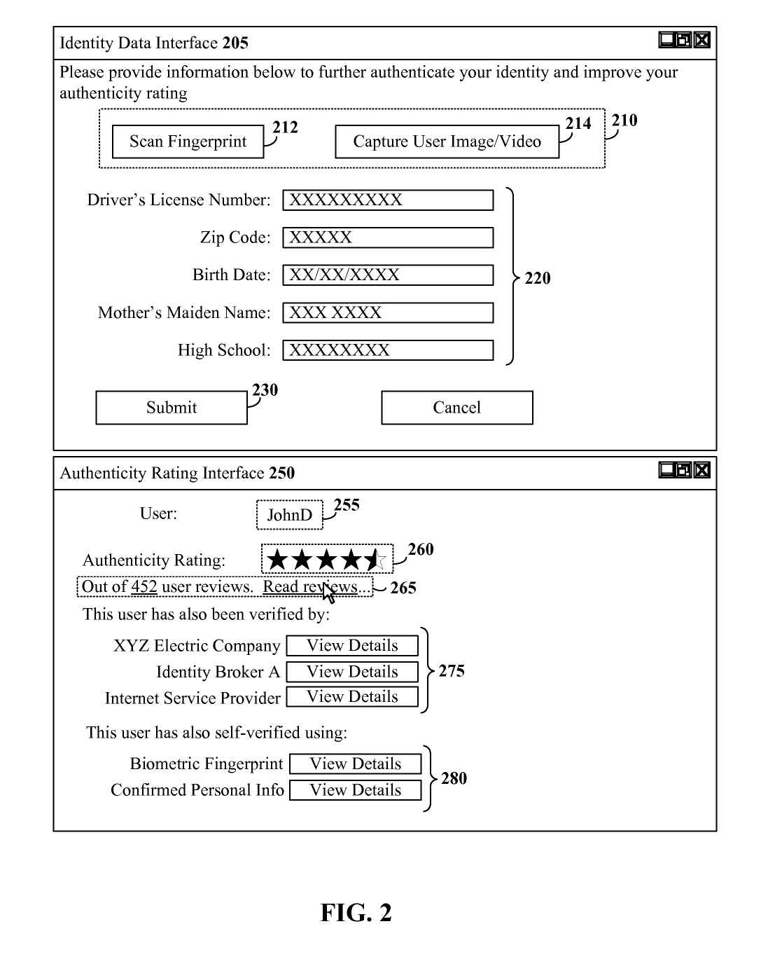

FIG. 2 illustrates a set of user interfaces 205, 250 associated with an authenticity rating in accordance with an embodiment of the inventive arrangements disclosed herein. The interfaces 205, 250 can be used in context of system 100.

Identity data interface 205 can be presented to a user to provide information that can verify their identity. Interface 205 can include one or more interface controls for providing a biometric 210 input. Biometric input can include a fingerprint 212, an image 214, typing characteristics, a speech sample (used in conjunction with a speaker identification and verification technique), and the like. Other verifiable inputs 220 can be entered via text controls. These inputs 220 can include datum related to a person, which is known by a person yet is often not known by others attempting to spoof an identity of another. For example, inputs 220 can include a driver's license number, a zip code, a birth date, a mother's maiden name, a high school that a user graduated from, and the like. In one embodiment, a portion of this information can be automatically verified using a trusted source. In another embodiment, inclusion of the information 220 can permit a community of users to more easily and accurately determine if an individual user has accurately represented himself or herself. For example, when input 220 is included in a profile (such as profile 142) other users may be able to verify or refute this information (i.e., other users attending a specified high school, for example, can verify or deny whether a user associated with an authentication rating attended that high school during a profile indicated period). Information input via interface 205 can be submitted 230 to a data store accessible by an authentication engine, which calculates the authenticity rating for the rated user. In one embodiment, the data 210, 220 entered in interface 205 can be data, which does not appear in a user's profile. At least a portion of the data 210, 220 can be verified by a data source, which a rated user is not able to edit.

Authenticity rating interface 250 can be presented to a user when they wish to view the authenticity rating of another user. Interface can show a variety of information regarding an authenticity rating 260 associated with a user 255. For example, each rating user can provide comments 265, which can be optionally viewed. If a user has been verified by one or more identity authorities, each of those authorities can be shown 275, along with details of the authentication. Further, self-verification data 280 and results can be provided in the interface 250.

In one embodiment, sensitive, confidential, and/or personal information can be hidden from others. For example, a rated user (JohnD) may not want others to know his full name or other information; yet, the rated user may want to permit others to know that the information included in a user profile is accurate. For instance, the user's profile can accurately indicate that the user is a thirty-eight year old male physician, who is married. Personal information, such as full name, address, social security information, etc., can be hidden from users of interface 250, even though some of this information may have been used by an identity authority (275) and/or when verifying user provided information 280. Thus, privacy and/or anonymity is able to be maintained for a rated user 255, while providing assurance to communicators interacting with the user 255 that the user 255 is not likely to be falsely representing himself.

It should be understood that interfaces 114, 205, 250 are presented for illustrative purposes only and that the disclosure is not to be limited in this regard. For example, different interface elements, arrangements, and types than those shown are contemplated and are to be considered within scope of the disclosure.

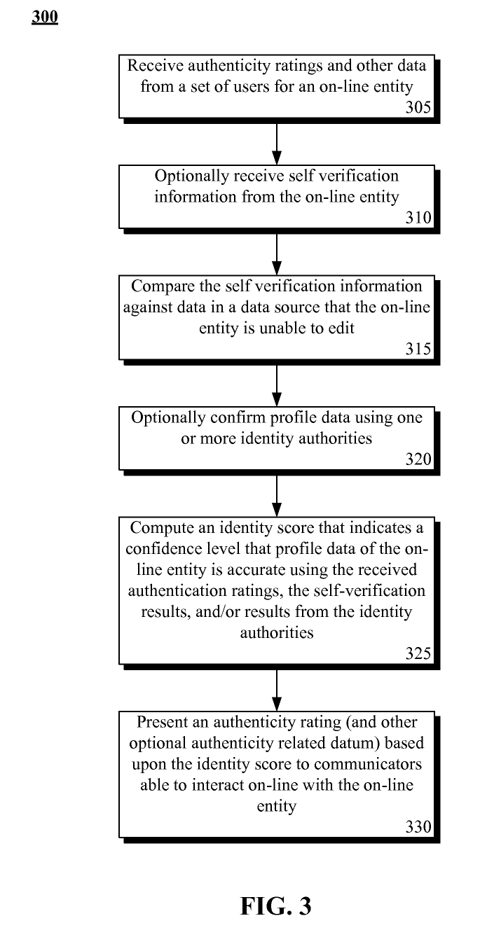

FIG. 3 is a flow chart of a method 300 for calculating authenticity ratings in accordance with an embodiment of the inventive arrangements disclosed herein. The method 300 can be performed in context of system 100. In one embodiment, the actions of method 300 can be performed by a machine executing instructions of a computer program product, which is digitally encoded in a storage medium.

Method 300 can begin in step 305, where an authenticity rating and related data can be received from a set of users. The authenticity rating can reflect whether a rater believes profile data associated with an on-line entity (who can be another user) is accurate. The related data can include comments provided by a rater concerning the on-line entity.

In optional step 310, self verification information can be received from the on-line entity. This self-verification information can include information entered into the profile as profile data as well as data not included in the profile data. Further, the self verification information can include sensitive and/or confidential information that is to remain hidden from others. In step 315, the self verification information can be compared against data from a data source, which the online entity is unable to edit.

In step 320, the profile data can be optionally confirmed using one or more identity authorities. Identity authorities can include, but are not limited to, a utility provider that provides a service to the on-line entity, an internet service provider for the on-line entity, a government authority that interacts directly with the on-line entity, an employer of the on-line entity, and the like. Each of the identity authorities can be a trusted source having knowledge regarding whether the information in the profile for the online entity is likely to be accurate. The identification authorities can have access to information related to the online entity, which is not included within the user profile. For example, a social security number, a driver's license number, a service account number, address information, and the like can be possessed by the identification authority. In one embodiment, one or more identification authorities can be a data source that confirms or refutes self-verification information provided by the on-line entity.

In step 325, an identity score can be computed using the received authentication ratings, results from the self-verification data, and/or results from the identity authority validations. The identity score can indicate a confidence level or likelihood that the profile data is accurate for the on-line entity.

In step 330, an authority rating based upon the identity score can be presented to communicators able to interact on-line with the on-line entity. For example, an authority rating of four out of five stars can be presented when the identity score is within a previously determined range of values. In one embodiment, the presentation of the authority rating can occur within a Web interface rendered within a Web browser. In one configuration, the interface can be one of multiple screens of a communication application, which can be used to communicate with the on-line entity. Further, additional information, such as rater provided comments, self-verified data provided by the on-line entity, identification authorities who have confirmed data of the profile, and the like can be optionally presented.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing identity assurance comprising:
providing a rating option within a user interface, wherein the rating option permits an interface user to provide a quantitative indication regarding an option of whether a profile detailing identification data for an on-line entity is accurate;
receiving rating input using the rating option from a plurality of raters;
calculating based at least in part upon the rating input from the plurality of raters an identity score that indicates a confidence level that the profile data of an on-line entity is accurate; and
presenting an authenticity rating based upon the calculated identity score to communicators able to interact on-line with the on-line entity.

2. The method of claim 1, further comprising:
establishing at least one identification authority, wherein an identification authority is a known entity able to utilize an external indicator associated with the on-line entity to confirm an accuracy of whether the profile data of the online-entity is accurate; and
utilizing authority metrics provided by the at least one identification authority when calculating the identity score, wherein the at least one identity authority comprises at least one of a utility provider that provides a service to the on-line entity, an internet service provider for the on-line entity, a government authority that interacts directly with the on-line entity, and an employer of the on-line entity.

3. The method of claim 1, further comprising:
receiving identity verification input from the on-line entity;
comparing the received identity verification input against data from a data source not editable by the on-line entity; and
calculating the identity score based at least in part upon comparison results.

4. The method of claim 1, further comprising:
presenting an indication to the communicators that indicates which, if any, identity authorities have been utilized to verify an accuracy of the profile data; and
presenting an indication to the communicators that indicates self-verified data provided by the on-line entity that has been confirmed by another source, wherein the self-verified data is data that is not included in the profile data, wherein the authenticity rating, the indication of identity authorities, and the indication of self-verified data is presented to the communicators within Web interfaces rendered in Web browsers.

5. The method of claim 1, further comprising:
receiving rating comments from the plurality of raters; and
presenting the rating comments to communicators able to interact on-line with the on-line entity.

6. A computer program product for providing identity assurance comprising a computer readable storage medium having computer usable program code embodied therewith, the computer usable program code comprising:
computer usable program code configured to provide a rating option within a user interface, wherein the rating option permits an interface user to provide a quantitative indication regarding an option of whether a profile detailing identification data for an on-line entity is accurate;
computer usable program code configured to receive rating input using the rating option from a plurality of raters;
computer usable program code configured to calculate based at least in part upon the rating input from the plurality of raters an identity score that indicates a confidence level that the profile data of an on-line entity is accurate; and
computer usable program code configured to present an authenticity rating based upon the calculated identity score to communicators able to interact on-line with the on-line entity.

7. The computer program product of claim 6, further comprising:
computer usable program code configured to establish at least one identification authority, wherein an identification authority is a known entity able to utilize an external indicator associated with the on-line entity to confirm an accuracy of whether the profile data of the online-entity is accurate; and
computer usable program code configured to utilize authority metrics provided by the at least one identification authority when calculating the identity score, wherein the at least one identity authority comprises at least one of a utility provider that provides a service to the on-line entity, an internet service provider for the on-line entity, a government authority that interacts directly with the on-line entity, and an employer of the on-line entity.

8. The computer program product of claim 6, further comprising:
computer usable program code configured to receive identity verification input from the on-line entity;
computer usable program code configured to compare the received identity verification input against data from a data source not editable by the on-line entity; and
computer usable program code configured to calculate the identity score based at least in part upon comparison results.

9. The computer program product of claim 6, further comprising:
computer usable program code configured to present an indication to the communicators that indicates which, if any, identity authorities have been utilized to verify an accuracy of the profile data; and
computer usable program code configured to present an indication to the communicators that indicates self-verified data provided by the on-line entity that has been confirmed by another source, wherein the self-verified data is data that is not included in the profile data, wherein the authenticity rating, the indication of identity authorities, and the indication of self-verified data is presented to the communicators within Web interfaces rendered in Web browsers.

10. The computer program product of claim 6, further comprising:
computer usable program code configured to receive rating comments from the plurality of raters; and
computer usable program code configured to present the rating comments to communicators able to interact on-line with the on-line entity.
